(19) United States
(12) Patent Application Publication
(10) Pub. No.: US 2021/0031555 A1
(43) Pub. Date: Feb. 4, 2021

(54) Driver's Identification Pack (a/k/a D.I.P.)

(71) Applicants: Sonya Latimore, Hollis, NY (US); Elise Latimore, Corona, NY (US)

(72) Inventors: Sonya Latimore, Hollis, NY (US); Elise Latimore, Corona, NY (US)

(21) Appl. No.: 16/529,707

(22) Filed: Aug. 1, 2019

(51) Int. Cl. B42F 17/30; B42F 17/16

(52) U.S. Cl. CPC B42F 17/30; B42F 17/16

(57) ABSTRACT

A compartment or device to store documents with or without a phone, visible from outside a vehicle whose contents are easily accessible by the driver, which could be built into or mounted on the car dashboard, or the like, with various mounting options, and allows a driver of the vehicle to reach the device without moving from the driver's seat or moving hands out of sight, and the contents are not so large as to possibly hold a gun or knife, but are sufficiently large to hold government documents about the identity of the driver and the ownership and insurance of the car. An electronic version, much like a cell phone, smart phone, tablet, which holds one or more government documents relating to the registered owner of a motor vehicle and can be easily attached to the dashboard or other interior surface of said vehicle, or a mounted phone rack which contents can be read or scanned by police.

### FIELD OF INVENTION

Utility

### CROSS REFERENCE TO RELATED APPLICATIONS

None

### FEDERALLY SPONSORED RESEARCH

None

### SEQUENCE LISTING

None

### BACKGROUND

When a driver is stopped by a police officer and is asked for their license and registration, a driver currently holds these documents in separate areas. A female driver usually looks for her driver's license in her purse and a male driver usually searches in his wallet from his back pocket. The registration and insurance card are typically thereafter retrieved from the glove compartment. This search by the driver can concern police officers and create suspicion as to whether the driver may reach for a weapon in their purse, back pocket, glove compartment or other area of the car. There have been several situations within the United States where this process has led to drastic and deadly occurrences where the drivers (usually minorities) have been fatally shot by police officers.

A case that stands out is the 2016 fatal shooting of Philandro Castile in St. Paul, Minn. where Officer Yanez feared that Mr. Castile was reaching for a gun after he was asked to show identification. Mr. Castile's girlfriend claimed that he was reaching for his identification, not a weapon.

Presently, there is no solution to assist with this problem. However, there is a need for some type of solution which will ease the concern of the police officer as well as the driver and/or passenger.

### BRIEF SUMMARY OF INVENTION

The present invention seeks to provide a solution to the problem of presenting required identification by certain States to be carried in the vehicle and presented to the police officers without creating concern and/or suspicion. It relates to a device or apparatus which will be placed or positioned on the dashboard of a motor vehicle. This invention will hold documents of various shapes and sizes which identify the owner of the motor vehicle, the car registration and the current insurance information.

More particularly, the Driver's Identification Pack or “D.I.P.” will be mounted on the driver's side of the dashboard (left in the United States and most countries of the European Union, and right in the United Kingdom and its colonies and territories). The D.I.P. will contain the proof of insurance, car registration and driver's license.

The D.I.P. will be clearly visible to law enforcement personnel and virtually eliminate the need for the driver or passenger to reach into the glove compartment, pocket, pocketbook, suitcase or other item which could house or hide a weapon, be it a gun, knife or other dangerous item or weapon. This invention could potentially reduce or even eliminate the misunderstandings and fear associated with random traffic stops.

The need for this invention arises from the outcry of American citizens related to the numerous police shootings of unarmed “minority” drivers in various state. Many of these shootings allegedly occur when drivers and/or passengers are asked to hand over their driver's license and vehicle registration. The mere fact that shootings have occurred while the drivers and/or passengers are reaching for this documentation in order to comply with local, state or other law enforcement personnel's instructions has necessitated this invention.

This invention provides an easy solution to a growing nationwide problem: traffic stops by police resulting in numerous shootings and in some cases, the death of unarmed Black and Hispanic drivers and passengers. Besides procedural retraining of police officers, the fear, stress, anxiety and over-caution of a random traffic stop can be virtually eradicated. Likewise, the safety of all concerned parties can be heightened by the D.I.P.

### BRIEF DESCRIPTION OF DRAWINGS

FIG. 1 is a front elevational view of the driver's identification pack and the translucent plastic placement pack comprised of three separated but attached sections indicated as numerals 1, 2 and 3. The entire product is rectangular in shape and is defined by the bottom edge 5 and the side edges 6 and 7. The first compartment indicated as numeral 1 has an opening on the top and will be closed by a zipper, Velcro or other fastener 8. It is smaller in size than the other compartments and designed to fit the State issued driver's license. It is centered in the middle of numeral 2.

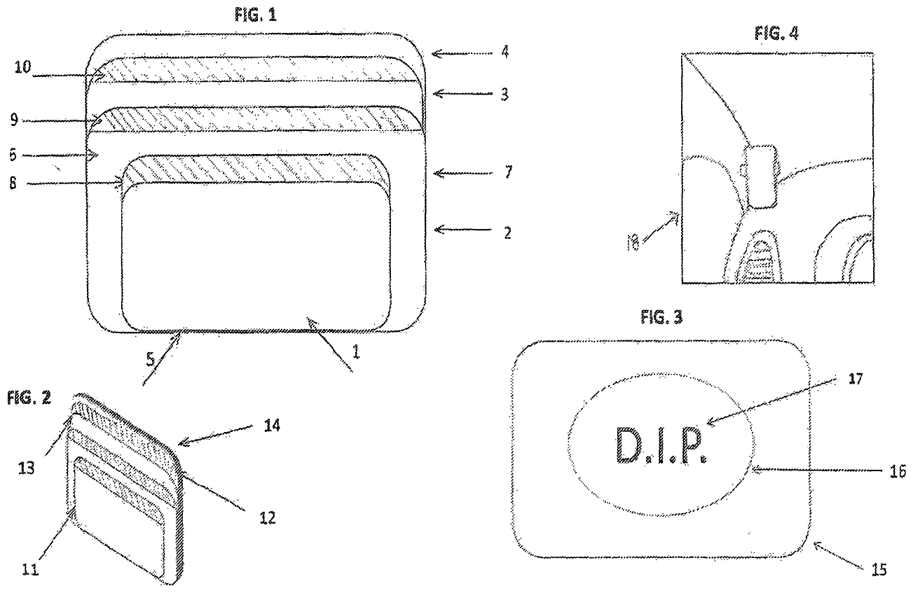

The second compartment indicated as numeral 2 has an opening on the top that can be closed by a zipper, Velcro or other fastener 9. This compartment 2 will hold the valid State registration. The top of the compartment is positioned lower than compartment 3 so that it can easily be accessed.

The third compartment indicated as numeral 3 has an opening at the top and will be closed by a zipper, Velcro or other fastener 10. This compartment is designed to hold the insurance card. It is positioned slightly lower than the backing of the driver's identification pack so that the enclosed documents can be easily accessed by opening the zipper, Velcro or other fastener attached.

The bottom 5 portion, the left side 6 and right side 7 of the driver's identification pack will be sealed with a permanent glue-type substance that will be compressed together under heated conditions and sealed at the bottom and top points of the driver's identification pack.

FIG. 2 is a side view of the driver's identification pack which demonstrates how the three compartments 11, 12, 13 are attached together by an adhesive backing 14. The back attachment 14 will be a flexible resilient rubber-like magnet which is a tough consistent substance.

FIG. 3 is the back view of the driver's identification pack with the attachment to secure the structure together. The back portion 15 can be apportioned on the top of the vehicle dashboard and can be directly engage the metal dashboard. If there is a variation in the contour of the dashboard, the structure can be deflected so that the magnet back can firmly engage the variable contour of the dashboard. The structure will remain in a fixed contact with the dashboard until forcibly removed therefrom, and the back portion can be removed from the dashboard surface to facilitate the cleaning thereof. The back also includes the advertising 16 display in large lettering indicating the acronym 17 of the driver's identification packet. Access to the documents in each compartment can be gained by opening the fastener and removing the document as needed.

FIG. 4 demonstrates where the driver's identification pack can be interfaced with a mounted mobile phone rack 18.

Various other modifications can be made from that described above, which will be revised based on each State's proportions of the driver's license, registration and insurance card. From the foregoing, it is seen that the device of this invention will accomplish at least all of its stated objectives.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present disclosure is to be considered as an exemplification of the invention, and is not intended to limit the invention to the specific embodiments illustrated by the figures or description below.

The present invention comprises a clear durable plastic placement pack. The pack will have three sections or slots. The first section, located at the back of the pack, will hold the vehicle registration. The second section, located in the middle of the pack, will hold the proof of insurance and the third section, located in the front pocket of the pack, will hold the driver's license. As demonstrated on the attached drawings, each section or slot will be attached to the other. To prevent or minimize loss of a document or water damage, each section will be enclosed by a zipper, Velcro or other fastener. Additionally, although the documents will be visible to the naked eye, the closures will allow each document to be removed separately, if necessary, by the driver or law enforcement. Also, each section can be flipped to view the document underneath.

The D.I.P. will be capable of being mounted on the dashboard of the motor vehicle, visible within reach of the driver and police. Additionally, in light of the fact that self-driving cars are on the horizon, the D.I.P. would be a useful tool in those circumstances.

The D.I.P. will be secured to the dashboard by either earth magnets, Velcro, 3M Dual Lock Tape/lock fastener (reputedly stronger than Velcro) or suction cups which will-be attached to the back of the D.I.P. The attachment should provide easy removal from the dashboard.

It should be noted that suction cup windshield mounts to support a GPS device or smartphone while driving may be illegal in some states. California and Maryland are two of ten states which allow GPS devices, toll payment systems and other safety monitoring equipment only when mounted as close to the bottom of the windshield as possible. Presently, sixteen States allow suction cup windshield mounts.

Another embodiment of the present invention will be an electronic version which will hold the three required documents in a case, similar in size and style of a smartphone or a small handheld tablet. This version will also be secured to the dashboard or interfaced with the parties' mounted mobile phone rack. The documents can be viewed successively by swiping the device right to left. The documents can be viewed by the police officer and/or scanned to verify the information.

The D.I.P. offers several advantages over storage of documents in glove compartments:
1. Visible to police;
2. Easy access and viewing;
3. Removable when you exit the vehicle;
4. Hands free operation; and
5. Reduces fear and misunderstandings.

There will be several versions of the D.I.P. at various prices as states have licenses and registrations in different sizes. Therefore, the D.I.P. can be specially ordered by a state, county, municipality or country. Another embodiment of the invention will allow for the D.I.P. to be interfaced onto the already existing dashboard or mounted mobile phone rack.

Unless a government mandates its use, each product will contain a disclaimer that:
(a) its usage is optional, not mandatory;
(b) there is no guarantee that usage will prevent stops by law enforcement, searches and/or seizures of property (legal or illegal); and
(c) abuse of power or any other conduct by police, law enforcement personnel or the owner/user of this product.

### POSSIBLE PRIOR ART

This driver's identification pack can be distinguished from existing document carrying cases. These cases are usually provided to individuals by their insurance carriers or car dealers. Most are plastic cases with a clear front. Some are shaped like holders for passports and airline tickets. These versions are usually stored in the car's glove compartment and do not possess the ability to be secured to the dashboard. This negates the intended purpose of the D.I.P which is visibility to police officers and passengers, easy retrievable of documents required to be produced during a traffic stop and reduction and fear of anxiety of all parties involved.

Another version holds the document with a case in the clear front to view the document. This version can be mounted on the car's sun visor. However, this version is also not clearly visible to the police and may not hold multiple documents.

Therefore, none of the above offer the advantages and benefits of the D.I.P. previously described herein.

1. A compartment or device to store documents with or without a phone, located in plain sight from outside a vehicle whose contents are easily accessible by the driver, which could be built into the car dashboard or mounted on the dashboard, steering column or the like, with mounting options that include suction cups, adhesives, Velcro, magnets or the like, and allows a driver of the vehicle to reach the compartment or device without moving from the driver's seat or moving hands out of sight, and the contents are not so large as to possibly hold a gun or knife, but are sufficiently large to hold government documents about the identity of the driver and the ownership and insurance of the car;

2. A compartment or device, as described in claim 1, comprising a carrying case constructed of various strong and durable materials including, but not limited to plastic or other materials, of various shapes, sizes and configurations and which holds one or more documents relating to the registered owner of a motor vehicle and can be easily attached to the dashboard or other interior surface of said vehicle or conform to a mounted phone rack;

3. A compartment or device, as described in claim 1, comprising at least one or more separate compartments to display items related to motor vehicle and driver identification, said compartment(s) being open at one end and functioning to facilitate the addition and removal of the displayed documents;

4. A compartment or device, as described in claim 1, which consists of a structure for protecting documents related to driver and motor vehicle identification from moisture, air, and other damaging elements while allowing viewing of the document from the exterior of the vehicle;

5. A compartment or device, as described in claim 1, having a method of fastening the encasement(s) so the documents contained therein are secure, easily retrievable, and waterproof;

6. A compartment or device, as described in claim 1, which is visible to police officers, drivers and/or passengers and negates the need to search the glove compartment, sun visor, side pockets or trunk of the vehicle, clothing pockets, pocketbooks or handbags, suitcases, or the like which holds documents required for production during random police traffic stops;

7. An electronic device, comprising a case, much like a cell phone, smart phone, tablet, or device of a similar configuration, which holds one or more government documents relating to the registered owner of a motor vehicle and can be easily attached to the dashboard or other interior surface of said vehicle, or the like, or a mounted phone rack, with the required documents contained in the device to be swiped from right to left or other direction to reveal the driver's identification and registration documents which can then be read or scanned by the police officer.
While illustrative embodiments of the invention have been shown and detail, it is to be understood that the invention is not limited to these precise embodiments, and that various changes and modifications can be effected therein, by a person skilled in the art, without departing from the scope or spirit of the invention, as defined in the aforementioned claims.
